(19) United States
(12) Patent Application Publication
(10) Pub. No.: US 2008/0143497 A1
(43) Pub. Date: Jun. 19, 2008

(54) Vehicle Emergency Communication Mode Method and Apparatus

(75) Inventors: Ryan J. Wasson, Grosse Pointe Park, MI (US); Christopher L. Oesterling, Troy, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: General Motors Corporation, Detroit, MI (US)

(21) Appl. No.: 11/611,371

(22) Filed: Dec. 15, 2006

(51) Int. Cl. B60Q 1/00

(52) U.S. Cl. 340/425.5

(57) ABSTRACT

A method and apparatus controls a communication mode of a mobile unit. Steps include detecting in the mobile unit an emergency signal; commencing a process of establishing communication from the mobile unit to a remote center in response to the detected emergency signal; providing an input prompt to a vehicle operator during the process of establishing communication with the remote center, wherein the input prompt requests response from the vehicle operator indicative of a status of emergency; canceling the communication if the response indicates there is no emergency; and completing the process of establishing communication from the mobile unit to the remote center if the canceling is not achieved.

### TECHNICAL FIELD

This invention relates to a vehicle emergency communication mode method and apparatus.

### BACKGROUND OF THE INVENTION

In a known example, a telematics unit in a vehicle communicates with a call center to provide useful services to subscribers, such as turn-by-turn navigation, hands-free calling, and other information related services. In a known example operation, a telematics unit establishes communication with the call center when an emergency event is detected, such as a vehicle crash. In another known example, during operation of the telematics unit, volume of the audio output in the vehicle is set to a predetermined minimum level to ensure the audio output from the telematics unit is not muted or minimized to a point at which a typical vehicle occupant cannot hear the audio output. During the emergency call, an operator at the call center follows procedures to communicate with the vehicle occupants and to contact emergency response officials to assist the vehicle occupants.

### SUMMARY OF THE INVENTION

According to an example, a vehicle emergency communication mode method includes: detecting at a mobile unit an emergency signal; commencing a process of establishing communication from the mobile unit to a remote center in response to the detected emergency signal; providing an input prompt to a vehicle operator during the process of establishing communication with the remote center, wherein the input prompt requests a response from the vehicle operator indicative of a status of emergency; canceling the communication if the response indicates there is no emergency; and completing the process of establishing communication from the mobile unit to the remote center if the canceling is not achieved.

According to another example, a vehicle emergency communication mode apparatus comprises: an input at a mobile unit detecting an emergency signal; a controller; communication hardware under control of the controller, wherein, responsive to the detected emergency signal, the controller and communication hardware commence a process of establishing communication with a remote center; a prompt control within the mobile unit providing an input prompt during the process of establishing communication with the remote center, wherein the input prompt requests a vehicle operator response indicative of a status of emergency; wherein the controller cancels the communication if the vehicle operator response indicates that there is no emergency, and wherein the controller and communication hardware complete the process of establishing communication with the remote center if the controller does not cancel the communication.

### DESCRIPTION OF THE DRAWINGS

FIG. 1 illustrates an example telematics system that controls emergency communication mode; and

FIG. 2 illustrates flow of an example method performed in the apparatus shown in FIG. 1.

### DESCRIPTION OF AN EXEMPLARY EMBODIMENT

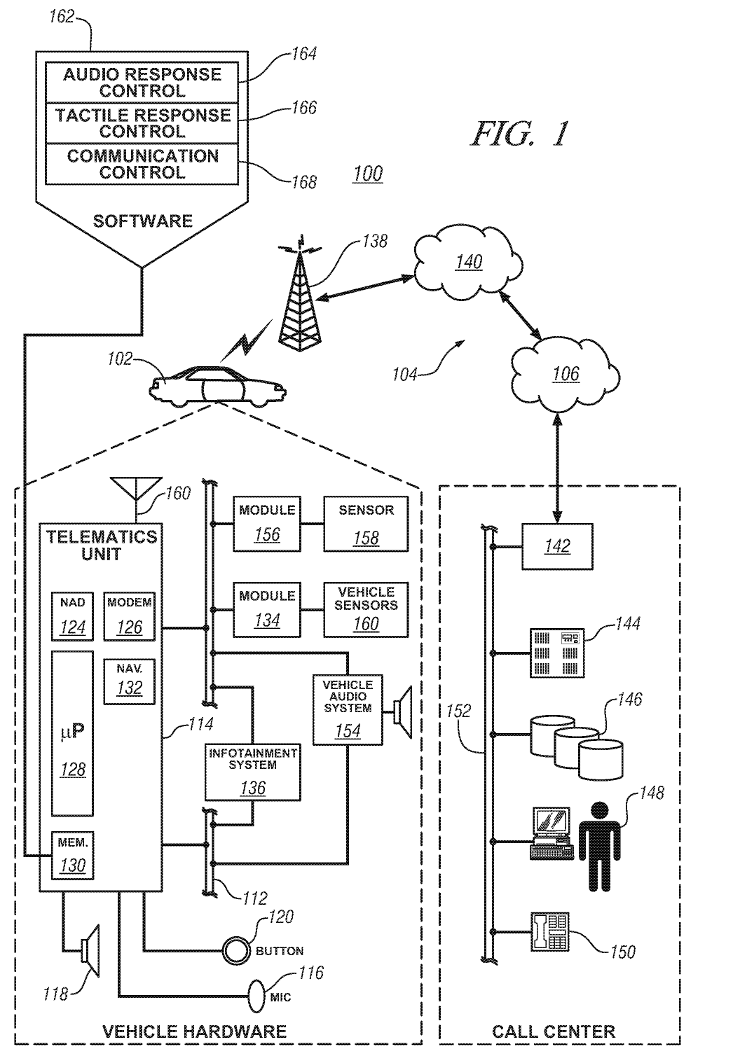

With reference to FIG. 1 there is shown an example of a system 100 that generally includes a vehicle 102, a wireless carrier system 104, a land network 106 and a call center 108. One skilled in the art in view of the description herein understands the operation of the system and its various components.

Vehicle 102 is preferably a mobile vehicle such as a motorcycle, car, truck, recreational vehicle (RV), boat, plane, etc., and is equipped with suitable hardware and software that enables the communications and functions described herein. Some of the vehicle hardware 110 is shown generally in FIG. 1 including a telematics unit 114, a microphone 116, a speaker 118 and buttons and/or controls 120 connected to the telematics unit 114. Operatively coupled to the telematics unit 114 is a network connection or vehicle bus 122. Examples of suitable network connections include a controller area network (CAN), a media oriented system transfer (MOST), a local interconnection network (LIN), a local area network, (LAN), an Ethernet, and other appropriate connections such as those that conform with known ISO, SAE, and IEEE standards and specifications, to name a few.

The telematics unit 114 is an onboard device that provides a variety of services through its communication with the call center 108, and generally includes a processor 128, one or more types of electronic memory 130, a cellular chipset/component (network access device) 124, a wireless modem 126, a dual antenna 160 and a navigation unit 132 containing a GPS chipset/component 132. In one example, the wireless modem is comprised of a computer program and/or set of software routines 162 stored in memory 130 and executing within processor 128.

The software 162 includes one or more control programs (not shown) for controlling unit 114 for known functions and for the additional control set forth herein. In addition, the audio response control 164 controls the audio input and output to the telematics unit 114, for example, to execute the internal voice response unit control. The tactile response control 166 controls the enabling and receiving of inputs, such as from pushbuttons 120. And the communication control 168 controls operation of the network access device 124 for establishing communication with a remote center. Each of these controls 164, 166 and 168 may have additional functions as describe herein or as known to those skilled in the art. Also, each may be implemented in a variety of different manners as set by the system designer, for example as individual software program modules, or as integrated components of a larger software control program module.

Many services are known and have been suggested for telematics unit 114, several examples include: turn-by-turn directions and other navigation-related services provided in conjunction with the GPS-based chipset/component 132; airbag deployment notification and other emergency or roadside assistance-related services provided in connection with various crash and or collision sensor interface modules 156 (only one shown) and sensors 158 located throughout the vehicle. The services may include infotainment-related services where music, Web pages, movies, television programs, videogames and/or other content are downloaded by an infotainment center 136 operatively connected to the telematics unit 114 via vehicle bus 122 and audio bus 112. In one example, downloaded content is stored for current or later playback.

Vehicle communications preferably use radio transmissions to establish a channel with wireless carrier system 104 so that both voice and data transmissions can be sent and received. Vehicle communications are enabled via the cellular chipset/component 124 for voice communications and a wireless modem 126 for data transmission. In order to enable successful data transmission over the voice channel, wireless modem 126 encodes the digital data for communication through a vocoder or speech codec incorporated in the cellular chipset/component part of network access device 124. Any suitable encoding or modulation technique that provides an acceptable data rate and bit error can be used with the present method. Dual mode antenna 160 services the GPS chipset/component and the cellular chipset/component.

Microphone 116 provides the driver or other vehicle occupant with a means for inputting verbal or other auditory commands, and can be equipped with an embedded voice processing unit utilizing a human/machine interface (HMI) technology known in the art. Audio output may be provided through speaker 118 or through a vehicle audio system 154, with associated speakers 155. For purposes of explanation, the operation will be described with reference to vehicle audio system 154 and speakers 155.

Microphone 116 and speaker 155 along with other hardware 110 enable occupants to communicate with call center 108 through audible speech. The buttons or controls 120 enable a vehicle occupant to activate or engage one or more of the vehicle hardware components 110. For example, one of the buttons 120 can be an electronic pushbutton used to initiate voice communication with call center 108 (whether it be a live advisor 148 or an automated call response system). In another example, one of the buttons 120 can be used to initiate emergency services by establishing a priority communication with call center 108.

The audio system 154 is operatively connected to the vehicle bus 122 and the audio bus 112. Analog audio is transmitted from telematics unit 114 to the audio system 154 through the audio bus 112 using a known audio arbitration process. Digital information is communicated via the vehicle bus 122. An example audio system 154 provides AM and FM radio, CD, DVD, and multimedia functionality, and may or may not be independent of the infotainment center 136 (subject to the discretion of the system designer).

The module 156 is operatively connected to the vehicle bus 122 and provides information to the telematics unit regarding the detection of a crash, and, in some implementations, additional information including the detected crash severity, angle of impact, and the amount of force.

Vehicle sensors 160 are connected to various sensor interface modules 134, which are operatively connected to the vehicle bus 122. Examples vehicle sensors include but are not limited to gyroscopes, accelerometers, magnetometers, emission detection and/or control sensors, and the like. Example sensor interface modules 134 include power train control, climate control, and body control, to name but a few. In another example, the telematics unit 114 contains integrated sensors and associated control that detect the occurrence of a crash or other emergency event.

Wireless carrier system 104 is preferably a cellular telephone system or any other suitable wireless system that transmits signals between the vehicle hardware 110 and land network 106. According to an example, wireless carrier system 104 includes one or more cell towers 138, base stations and/or mobile switching centers (MSCs) 140, as well as any other networking components required to connect the wireless system 104 with land network 106. As appreciated by those skilled in the art, various cell tower/based station/MSC arrangements are possible and could be used with wireless system 104. For example, a base station and a cell tower could be co-located at the same site or they could be remotely located, and a single base station could be coupled to various cell towers or various base stations could be coupled with a single MSC. Preferably, a speech codec or vocoder is incorporated in one or more of the base stations, but depending on the particular architecture of the wireless network, it could be incorporated within a Mobile Switching Center or some other network components as well.

Land network 106 can be a conventional land-based telecommunications network that is connected to one or more landline telephones and connects wireless carrier network 104 to call center 108. For example, land network 106 can include a public switched telephone network (PSTN) and/or an Internet protocol (IP) network, as is appreciated by those skilled in the art. Of course, one or more segments of the land network 106 can be implemented in the form of a standard wired network, a fiber of other optical network, a cable network, other wireless networks such as wireless local networks (WLANs) or networks providing broadband wireless access (BWA), or any combination thereof.

Call center 108 is designed to provide the vehicle hardware 110 with a number of different system back-end functions and, according to the example shown here, generally includes one or more switches 142, servers 144, databases 146, live advisors 148, as well as a variety of other telecommunication and computer equipment 150 that is known to those skilled in the art. These various call center components are preferably coupled to one another via a network connection or bus 152, such as the one previously described in connection with the vehicle hardware 110. Switch 142, which can be a private branch exchange (PBX) switch, routes incoming signals so that voice transmissions are usually sent to either the live advisor 148 or an automated response system, and data transmissions are passed on to a modem or other piece of equipment 150 for demodulation and further signal processing. The modem 150 preferably includes an encoder, as previously explained, and can be connected to various devices such as a server 144 and database 146. For example, database 146 could be designed to store subscriber profile records, subscriber behavioral patterns, or any other pertinent subscriber information. Although the illustrated example has been described as it would be used in conjunction with a manned call center 108, it will be appreciated that the call center 108 can be any central or remote facility, manned or unmanned, mobile or fixed, to or from which it is desirable to exchange voice and data.

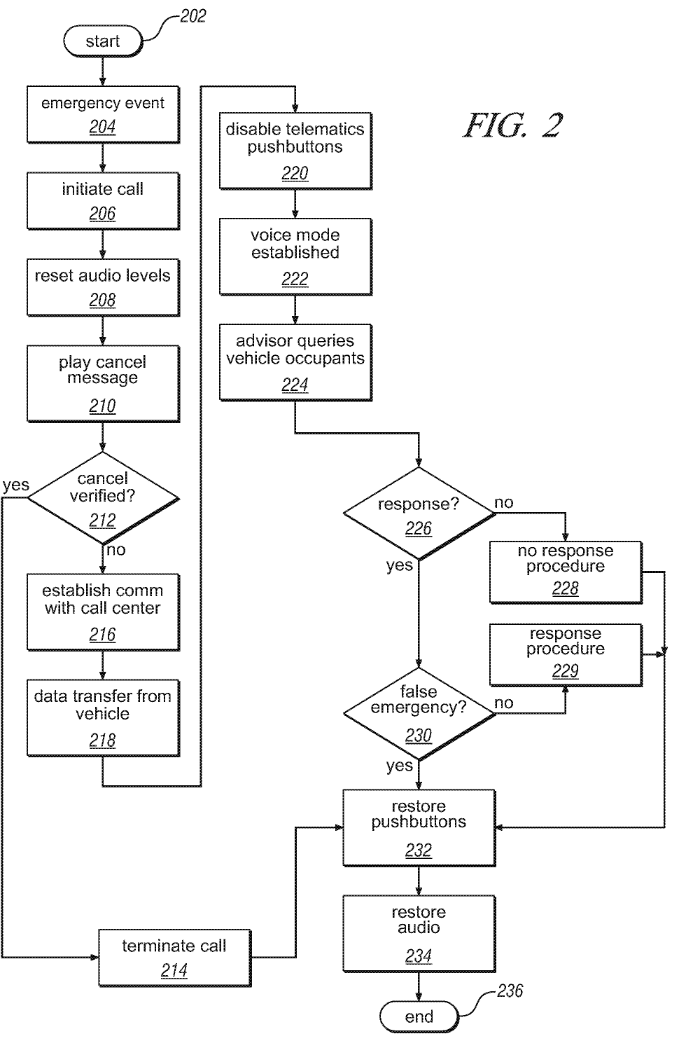

Referring now also to FIG. 2, the example method shown can be carried out within the operating environment of the telematics system 100 described above. The method 200 begins at 202, which represents typical operation of known or other features of telematics unit 114 not central to this invention.

At step 204, an emergency event is signaled by, for example, a vehicle occupant pressing a button 120, a module 156 deploying a supplemental inflatable restraint, or a module (134 or 156) detecting sudden vehicle acceleration or other parameter indicative of a crash or other emergency vehicle event. The signal may be a communication received over the bus 122.

At step 206, responsive to the signaled emergency event 204, the telematics unit 114 initiates an emergency call to the call center 108, preferably using network access device 124. Typically, a period of time elapses to complete the connection for the call. In one example, the time elapsed from the signaled emergency event 204 to establishing communication with a call center ranges from about eleven seconds to twenty seconds. This time period is utilized as explained below.

At step 208, the telematics unit then takes control of the vehicle audio system 154, including speakers 155, sending one or more messages across the vehicle bus 122 or 112 to reset the current audio volume level, in effect seizing control thereof to ensure operation at no less than a predetermined audio volume.

For example, in convention operation, the telematics unit may, via vehicle bus 122 or entertainment bus 112, set a first predetermined minimum lower or floor volume level for the audio system 154 at about sixty-five decibels, to be output on speaker 118 and/or audio system 154 speakers 155. This control disables operator attempted volume adjustments below this minimum value. During an emergency call, a second predetermined minimum volume level may be set, higher than the first predetermined minimum volume level, to provide higher minimum volume operation in an emergency event. Thus, in operation, regardless of the volume level of the audio system 154 prior to the emergency event, the volume is set to the second predetermined minimum volume level after an emergency event signal is detected. In another example, during the emergency event, the audio volume is initially set to the second predetermined minimum volume, but the vehicle operator may adjust it to another minimum, such as the first predetermined minimum, while not having the ability to reduce volume any further during the emergency communication. In this example, then, the second minimum is the nominal volume automatically set during an emergency call, and the first minimum is the minimum below which an operator cannot adjust the audio volume during the emergency call.

Depending upon the emergency mode signaled—for example, if it is a button press—audio response control 164 plays a cancel message in step 210, querying the vehicle occupants whether an emergency event 204 actually occurred. For example, if the buttons 120 are located on a rear view mirror, one of the vehicle occupants, typically the driver, may inadvertently press a button 120 used to activate emergency services while adjusting the rear view mirror. The cancel message, in one example, is stored in the telematics unit memory 130 and is played over speaker 118 or audio system 154 responsive to the emergency event. In this example, the cancel message prompts, “If you pressed the emergency button in error, please press the phone button to disconnect”. The vehicle occupants may then press one of the buttons 120, for example, the button 120 associated with making wireless calls via the vehicle communications device 112. By pressing the button 120, the vehicle occupant or occupants may terminate the initiated emergency call from the telematics unit 114 to the call center 108. Thus, during the time period between the signaled emergency event 204 and the established communication with a call center, the vehicle 102 occupants have an opportunity to terminate the initiated emergency call from the mobile vehicle.

Step 212 tests whether the cancel message 210 was verified by the vehicle occupant or occupants via a button 120 press. If the cancel message 210 is indeed verified, then the method advances to step 214, where the emergency call from the telematics unit 114 to the call center 10 is terminated. The method then advances to step 232, described below.

If the cancel message is not verified, then the method advances to step 216, where communication is established between the telematics unit 114 and the call center 108. The communication begins with a data mode that, for example, allows vehicle information to be passed from the vehicle hardware 110 to the call center 108. In this example, data mode is distinguished from voice mode, where data mode only allows data to be transferred, and voice mode only allows verbal communication. In another example, data transfer and voice mode may be simultaneously enabled and active.

As seen in step 218, data is transferred from the vehicle hardware 110 to the call center 108 responsive to step 212. For example, the data transferred to the call center may comprise a Vehicle Identification Number (VIN), vehicle position expressed in radians and/or latitude and longitude values, a serial number identifying the telematics unit 114, a station identifier (STID), the emergency event type and associated data, the speed and direction of the vehicle 102 and/or combinations thereof.

Once the data in step 218 is transferred to the call center 108, the buttons 120 are disabled as seen in step 220. This prevents movement or activity in vehicle 102 from terminating the emergency call once a connection is established and data is being transferred to the call center 108. Disabling the buttons 120 in step 220 prevents inadvertent termination of the emergency call and helps facilitate communication of the emergency event by a vehicle 102 occupant.

At step 222, voice mode is established, allowing verbal communication between the vehicle 102 occupants and a call center advisor 148. The method then advances to step 224.

At step 224, the call center advisor 148 queries the vehicle 102 occupants regarding the emergency. The advisor typically will attempt to elicit a response 226 from the vehicle occupants, asking them, for example, about the nature of the emergency, if anyone is injured, and the like. If the call center advisor 148 does not receive a response, the method advances to step 228 where the call center advisor 148 follows procedures set by the business for handling no-response emergency calls. If the vehicle 102 occupants respond, then the method advances to step 230.

In step 230, the call center advisor, in one example, will query the vehicle 102 occupants, asking if an emergency situation exists. If the vehicle 102 occupants confirm that an emergency condition exists, the call center advisor 148 will follow response procedure 229, set by the business according to its internal criteria for handling emergency matters. The method then advances to step 232.

If the vehicle 102 occupants instead confirm that no emergency condition exists, the method advances to step 232.

As seen in step 232, the buttons 120 are restored to normal functionality, typical of system operation when not in an emergency. The method advances to step 234 where the audio level control is released and the vehicle occupants may again control the volume level. For example, after the restoring step 234, the vehicle 102 occupants are able to decrease the volume below the minimum used for emergency events and increase the volume above the maximum. The method steps terminate at 236.

It is to be understood that the foregoing description is not a description of the invention itself, but of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A vehicle emergency communication mode method comprising the steps of:
detecting at a mobile unit an emergency signal;
commencing a process of establishing communication from the mobile unit to a remote center in response to the detected emergency signal;
providing an input prompt to a vehicle operator during the process of establishing communication with the remote center, wherein the input prompt requests a response from the vehicle operator indicative of a status of emergency;
canceling the communication if the response indicates there is no emergency; and
completing the process of establishing communication from the mobile unit to the remote center if the canceling is not achieved.

2. The method of claim 1 wherein the emergency signal is initiated by a button press.

3. The method of claim 1 wherein certain inputs to the mobile unit are disabled when the communication with the remote call center is established.

4. The method of claim 1 wherein, after the emergency signal is detected, a minimum audio output volume is set at a predetermined level associated with emergency communication.

5. The method of claim 3 wherein the certain inputs include push button inputs.

6. The method of claim 1 wherein the response indicating there is no emergency comprises a voice input.

7. The method of claim 1, wherein the emergency signal is initiated by one of a button press and a signal from a control module coupled to the mobile unit through a local communication connection.

8. The method of claim 1 wherein the response indicating there is no emergency comprises a push button input.

9. The method of claim 8 wherein the canceling is responsive to the pushbutton input.

10. The method of claim 5 wherein the certain pushbutton inputs are re-enabled after a termination of the communication.

11. The method of claim 1 wherein the input prompt is provided through an audio interface controlled by the mobile unit.

12. A vehicle emergency communication mode method comprising the steps of:
detecting at a mobile unit an emergency signal initiated by a first press of a button;
commencing a process of establishing communication from the mobile unit to a remote center in response to the detected emergency signal;
providing an input prompt through an audio interface controlled by the mobile unit to a vehicle operator during the process of establishing communication with the remote center, wherein the input prompt requests a response from the vehicle operator to execute a second press of the button if there is no emergency;
canceling the communication if the response includes the push of the button indicating that there is no emergency;
if the canceling is not achieved, then
completing the process of establishing communication from the mobile unit to the remote center;
disabling certain push button inputs to the mobile unit after establishing communication from the mobile unit to the remote center;
terminating the communication from the mobile unit to the remote center; and
after the terminating, re-enabling the certain push button inputs.

13. A vehicle emergency communication mode apparatus comprising:
an input at a mobile unit detecting an emergency signal;
a controller;
a communication hardware under control of the controller, wherein, responsive to the detected emergency signal, the controller and the communication hardware commence a process of establishing communication with a remote center;
a prompt control within the mobile unit providing an input prompt during the process of establishing communication with the remote center, wherein the input prompt requests a vehicle operator response indicative of a status of emergency;
wherein the controller cancels the communication if the vehicle operator response indicates that there is no emergency, and
wherein the controller and communication hardware complete the process of establishing communication with the remote center if the controller does not cancel the communication.

14. The apparatus of claim 13 also comprising a push button control disabling push button inputs to the mobile unit when the communication with the remote call center is established.

15. The apparatus of claim 13 also comprising an audio response control setting minimum audio output volume at a predetermined level associated with emergency communication in response to the detected emergency signal.

16. The apparatus of claim 13, also comprising a pushbutton for initiating the emergency signal.

17. The apparatus of claim 13, wherein the input is coupled to an in-vehicle communication link receiving the emergency signal from a module coupled to the in-vehicle communication link.

18. The apparatus of claim 13, wherein the prompt control includes an audio interface.
